(19) United States
(12) Patent Application Publication
(10) Pub. No.: US 2003/0021938 A1
(43) Pub. Date: Jan. 30, 2003

(54) Forming new sheet flooring widths by controlling application of a bonding agent

(76) Inventors: David A. Kraft, Lancaster, PA (US); Jennifer W. Sager, Salunga, PA (US)

Correspondence Address: WOMBLE CARLYLE SANDRIDGE & RICE, PLLC, P.O. Box 7037, Atlanta, GA, 30357-0037, US

(21) Appl. No.: 09/917,360

(22) Filed: Jul. 27, 2001

(51) Int. Cl. B32B 3/00

(52) U.S. Cl. 428/58; 428/61; 156/158; 156/304.1

(57) ABSTRACT

Methods for creating relatively wide surface coverings and surface covering components by seaming together relatively narrow surface coverings and surface covering components are disclosed. The surface coverings are seamed together with a barely visible or invisible seam by lining up two sheets together and taping them together on one surface at the seam. In one embodiment, the taped surface is the top surface of a surface covering, i.e., the surface that includes the design. The sheets can include thermoplastic polymers. The taped surface is placed downward, and a gluing surface is exposed. The gluing surface is the surface on the two surface coverings to be joined that are in contact with each other. The gluing surface can either be exposed by raising the taped region or by lowering one or both sides adjacent the taped region. A suitable adhesive is applied to the gluing surface, and the raised region is lowered or the lowered sides are raised to the original height. Excess adhesive is optionally but advantageously removed, for example, by wiping or skiving the excess off of the non-taped surface, and the adhesive is allowed to set. The method is advantageously used to join together two pieces of thermoplastic sheeting, particularly flooring. If the two pieces are aligned so that they have a pattern similar to the printed pattern of the sheeting, the resulting surface covering appears virtually seamless.

### FIELD OF THE INVENTION

This invention relates to a roll of surface covering or surface covering component in which two pieces of thermoplastic sheeting, particularly flooring, are joined together. More specifically, two pieces of similarly patterned polyvinyl chloride resilient sheet flooring can be joined together in a manner that disguises the joined area and forms a water-tight, sealed assembly. The pattern may be any multicolored design or image, including wood grain, marble and fanciful.

### BACKGROUND OF THE INVENTION

The widths of decorative sheet flooring materials have generally been limited to about twelve feet due to the size of the manufacturing equipment. While twelve foot wide material is satisfactory for most applications, there is some demand for larger widths, and the demand appears to be increasing for such greater widths, particularly for the manufactured home industry.

Machines capable of producing sheet flooring materials with widths greater than twelve feet tend to be very large and expensive. Furthermore, regardless of what greater width machine is selected, there may always be some market for product of even greater width.

Wider sheet flooring products can be prepared by seaming together two or more sheets together to form a wider sheet. While there are several acceptable means for seaming floors together, there are limitations associated with some seaming methods. These limitations include poor seaming techniques used by installers, seams pulling apart over time and/or acting as a dirt trap, and poor visible appearance. Methods for seaming narrow sheets together to form wider sheets are described, for example, in U.S. Pat. No. 6,083,595 and U.S. Ser. No. 09/298,287, the contents of each of which are hereby incorporated by reference.

It would advantageous to manufacturers and installers of resilient sheet flooring if there were methods for manufacturing rolls of sheet flooring materials with a high strength, high performance seam and that provided resilient sheet flooring of any desired width, and sheet flooring materials prepared using such methods. This would allow an installer to install a floor without having to create a weaker seam during the installation process. The present invention provides such methods and floor coverings.

### SUMMARY OF THE INVENTION

Methods for seaming surface coverings and surface covering components, and surface coverings and surface covering components prepared using the methods are disclosed. In one embodiment, the surface coverings and surface covering components are wider than can be prepared commercially without seaming narrower pieces together. The width can be varied over a wide range, and is essentially unlimited.

The surface coverings and surface covering components are formed from two sheets seamed together with a barely visible or invisible seam. The sheets are lined up and taped together on one surface at the seam, or otherwise held with a suitable sheet holding means, preferably in a manner that preserves a desired pattern or design if one is present. In one embodiment, the taped surface is the top surface of a surface covering, i.e., a surface that includes a design. The sheets can include thermoplastic polymers.

In one embodiment, the taped surface is placed downward, and a gluing surface (the surface on the two surface coverings to be joined that are in contact with each other) is exposed. The gluing surface can either be exposed by raising the taped region or by lowering one or both sides adjacent the taped region.

A suitable adhesive is applied to the gluing surface, and the raised region is lowered or the lowered sides are raised at least to the original height. Any suitable means for raising or lowering the respective portions of the sheets can be used. In one embodiment, the means is a mandrel.

Excess glue is preferably removed, for example, by wiping or skiving the excess off of the non-taped surface. After the adhesive has set, the tape can be removed and/or the surface covering can be rolled up and/or installed. The edges of the first and second sheets can be shaped to define, when positioned closely adjacent each other, a predetermined void within the seam for retaining adhesive.

The method is advantageously used to join two or more pieces of thermoplastic sheeting, particularly sheet flooring, together. If the two or more pieces are aligned so that they have a pattern similar to the printed pattern of the sheeting, the resulting surface covering can appear seamless.

Where the adhered sheets are finished surface coverings, they can be used directly as surface coverings, for example, floor coverings, that in one embodiment have a matching pattern along the seam. When the adhered thermoplastic sheets are surface covering components, further elements, for example, UV-curable top coat formulations, can be applied to the adhered sheets. This can be particularly relevant where the equipment for making all of the elements of a surface covering but a top coat layer is limited to a certain product width, but where a top coat can be applied to a wider product width.

Alternatively, it is possible to apply and dry/cure a top coating onto the seamed product after installation in the field. This also includes the application of and curing of field applied UV top coat materials. In this case, the top coating should adhere to the seamed area and also not interact with the seamed area in any way to present any significant difference in the performance of the seamed region versus the rest of the coated product. Using the methods described herein, existing equipment can be used to prepare surface covering components, the components adhered together, and used in one or more additional steps to prepare completed surface coverings.

The glue surface can be but need not be perpendicular to the top surface, and the seam can be substantially a straight line, although the seam can deviate from a straight line to the extent it is still possible to tape the matched sheets and expose a gluing surface. The seam can but need not run parallel to a printed pattern or design. Examples of suitable adhesives include hot melt glue, cyanoacrylates, urethanes, and acrylates.

In one embodiment, the seam area does not scratch, stain, or discolor at a faster rate than the remainder of the surface covering during the “in use” life of the product. In another embodiment, the strength of the seamed area exceeds that of the remainder of the surface covering.

### BRIEF DESCRIPTION OF THE DRAWINGS

FIGS. 1A and 1B are illustrations of two pieces of vinyl sheet flooring that are cut at an angle and pattern matched, taped together at the seam, and raised to provide a controlled opening in the seam.

FIG. 2 is an illustration of two pieces of vinyl sheet flooring that are cut and pattern matched.

FIG. 3 is an illustration of two pieces of vinyl sheet flooring that are adhered together at a seam and held in a “U” shape with the seam at the bottom of the “U.”

### DETAILED DESCRIPTION

Methods for seaming surface coverings and/or surface covering components, and surface coverings and surface covering components prepared using the methods, are disclosed. In one embodiment, the surface coverings and surface covering components are wider than can be prepared commercially without seaming together narrower pieces. The method permits the production of patterned floor product of any desirable width, and assures that the decorative pattern on the new product can remain without visible discontinuities.

The method is advantageously used to join two or more pieces of sheeting together. The sheeting can be, for example, thermoplastic sheeting, particularly flooring. If the two pieces are aligned so that they have a pattern similar to the printed pattern of the sheeting, the resulting surface covering can appear seamless. Further, the sheets can be adhered at ambient low temperature, without subjecting the sheets to high heat that might discolor or otherwise adversely effect the sheets.

The two or more sheets can be used in floor coverings, and can have a matching pattern along the seam. Alternatively, the sheets can be of different colors. The glue surface can be but need not be perpendicular to the top surface, and the seam can be substantially a straight line. The seam can but need not run parallel to a printed pattern or design.

In one embodiment, the seam area does not scratch, stain, or discolor at a faster rate than the remainder of the surface covering during the “in use” life of the product. In another embodiment, the strength of the seamed area exceeds that of the remainder of the surface covering.

Surface Coverings

Surface coverings are well known to those of skill in the art, and include, for example, floor coverings and wall coverings. The surface coverings are formed from two or more sheets seamed together with barely visible or invisible seams. The surface coverings can include various layers, for example, a substrate, one or more foamed layers, wear or strengthening layers, design/decorative layers, and/or top coat layers. The surface coverings can be of any suitable thickness for their intended use. In one embodiment, the thickness is between about 20 and 125 mils.

The surface coverings can include a print layer that includes a pattern such as wood grain, marble or fanciful. The print layer can include a repeated pattern. The pattern can be virtually any type of design used in floor coverings.

Substrates suitable for use herein include all substrates known to practitioners in the art, including but not limited to solid, filled or unfilled polymeric layers or composites; solid layer composites comprising fibrous webs saturated with polymeric binder; one or more porous fibrous layers, such as but not limited to beater saturated felts; non-woven fabric materials; paper; solid backings, such as but not limited to vinyl, optionally made on a release carrier, and combinations thereof, which typically are coated with additional layers such as wear layers, strengthening layers and decorative layers. Floor coverings typically include a wear layer and/or a topcoat layer. In one embodiment, the topcoat layer is a UV-cured layer.

In one embodiment, the surface covering includes two elements, each element including a first major surface and a second major surface, with a gluing surface interposed between the first surface and the second surface. The gluing surfaces of the two elements are adjacent, and an adhesive is interposed between the gluing surfaces. The surface covering can be in the form of a roll, with the gluing surfaces being in a plane perpendicular to the axis of the roll. The gluing surfaces and adhesive form a seam, and in one embodiment, the thickness of the seam is substantially no greater than the thickness of the elements. In this embodiment, when the surface covering is rolled up, there is no increased thickness at the seam that will cause problems as the roll gets thicker. This is advantageous over seams that are substantially thicker than the sheets that are adhered, because the increase in thickness is cumulative as the roll increases in thickness, and can cause problems.

Surface Covering Components

A surface covering component is any substrate combined with one or more layers, applied in any manner known in the art, which is not yet a commercially ready product. Surface covering components include one or more layers such as substrates, foamed layers, pattern layers, wear layers, top coat layers and the like.

Thermoplastic Materials

Thermoplastic materials which can be used to make thermoplastic sheeting that can be present in the surface coverings and/or surface covering components include polyvinyl chloride, acrylonitrile/butadiene/styrene, thermoplastic polyurethane, and polyolefins such as polypropylene, polyethylene, ethylene octane copolymers, ethylene/styrene copolymers, and ethylene/propylene copolymers. Other thermoplastic resins that can be used include polyvinyl acetate, cellulose acetate, polystyrene, ethyl cellulose, polyvinylidene chloride, polyurethane, nylon, acrylic, and polyphenylene oxide. Examples of specific thermoplastic resins include polyvinyl chloride homopolymers and copolymers with acetate functionality, and mixtures thereof.

Plasticizers

Many of the thermoplastic materials described above, for example, PVC, can be formed into fused plastisol layers using plasticizers. Examples of representative plasticizers that can be used include butyl cyclohexyl phthalate, tri(butoxyethyl) phosphate, trioctyl phosphate, 2-ethylhexyl diphenyl phosphate, dibutyl phthalate, diisobutyl adipate, epoxidized di(2-ethylhexyl) tetrahydrophthalate, di(2-ethylhexyl) phthalate, diisooctyl phthalate, dioctyl adipate, diisononyl phthalate, di(2-ethylhexyl) hexahydrophthalate, n-octyl, n-decyl phthalate, tricresyl phosphate, butyl benzyl phthalate, dicapryl phthalate, di(3,5,5-trimethylhexyl) phthalate, diisodecyl phthalate, di(2-ethylhexyl) adipate, butyl epoxy stearate, epoxidized soya oil, epoxidized octyl tallate, dimethyl phthalate, hexyl epoxy stearate, cresyl diphenyl phosphate, di(2-ethylhexyl) isophthalate, n-octyl, n-decyl adipate, di(2-ethylhexyl) azelate, epoxidized octyl oleate, di(2-ethylhexyl) sebacate, tetraethylene glycol/di(2-ethyhexoate), diisodecyl adipate, and triethylene glycol/di(2-ethylhexoate) and combinations thereof. The plasticizer should be compatible with the adhesive/bonding material so as to not weaken the bond over time.

Adhesives/Bonding Materials

The adhesive/bonding material should be fluid when applied and have acceptable processing within the seaming process, permit the adhered sheets to meet product strength requirements, and have acceptable performance when the surface is exposed when the final product is installed. Any adhesive/bonding material can be used that provides adequate seam strength and has acceptable surface performance once installed. Depending on the adhesive used, the seam strength in some embodiments exceeds the strength of the thermoplastic materials. In other words, if the product were subjected to a tensile strength test to failure, for example, ASTM D 6380, the product would fail within itself and not at the seam.

Acceptable surface performance means the seam area will not pick up dirt, scratch, discolor due to light or aging, or discolor due to staining agents significantly different from the rest of the product surface.

Bonding materials/adhesives such as hot-melt, light-curable or UV-curable (for example, acrylates), thermal, moisture-curable (for example, urethanes) and anaerobic-curable (for example, cyanoacrylates) can be used. Suitable adhesives are disclosed, for example, in U.S. Ser. No. 09/298,287, the contents of which are hereby incorporated by reference. A number of suitable adhesives are commercially available from Loctite Corporation. Loctite 406 is an example of a suitable cyanoacrylate adhesive.

To provide adequate bonding, the adhesive must be fluid enough to easily flow into the opened seam and wet out all the surfaces and flow into microcracks, or rough surfaces, and form a strong adhesive bond at the interface with the sheet product before solidifying or curing.

In one embodiment, the adhesive is fluid until the seam is closed from the back and excess adhesive is removed. Once the excess adhesive is removed, the faster the adhesive sets/solidifies/cures the better. Where the adhesive/bonding material requires a light cure, or thermal or chemical activation, this can be accomplished on line before the material is transported off the seaming table/area.

The adhesive is advantageously completely or at least partially cured before the adhered sheets are transported off the seaming table/area. If partially cured, the degree of cure should be enough so that the adhered sheets do not separate. Further curing can occur after the adhered sheets are transported off the seaming table/area.

Hot melt bonding materials can be used, but may require special handling requirements. Typically, the hot melt materials are heated sufficiently to provide a low viscosity, and, optionally, a heated applicator is used to apply the hot melt to the seam. In one embodiment, heat is applied from the backside of the product to keep the materials liquid. After the seam is formed, the sheet can be cooled to preserve the seam.

The low viscosity allows the hot melt materials to wet out and flow into edge areas to create bonding strength. It is important to fill and close the seam while the hot melt is still fluid. Advantageously, appropriate measures are used to minimize and remove excess adhesive.

Cyanoacrylate type (anaerobic) adhesives are particularly useful in that they form very strong bonded seams, and that they cure rapidly when the seam is closed.

The seams can be pre-treated with a curing catalyst or reactive material that either facilitates curing of the bonding material or facilitates wet out and increases seam strength. Alternatively, curing catalysts can be post-applied to the seams to facilitate adhesive curing rate. Examples of catalysts or reactive materials include accelerators for isocyanate moisture reactions, epoxy curing catalysts or co-reactants, peroxide initiators, photoinitiators, and the like. Those of skill in the art can readily identify catalysts and/or reactive materials such as adhesive accelerators that are compatible with the adhesive/bonding material and the particular curing/adhering chemistry. Loctite 7452 is an example of a suitable adhesive accelerator that can be used.

Tape and Other Sheet Holding Means

Tape is an example of a means for holding the sheets together in a desired orientation. However, clamps, presses and other means for holding sheet materials in place can be used provided that the glue surface can be exposed without disrupting the alignment of the sheets. In one embodiment, clamping means are used in combination with the tape to hold the seam together until the gluing surface is exposed.

Examples of suitable tapes that can be used include clear tapes from the 3M corporation, for example, 3M 471 transparent plastic tape.

Sheet Raising/Lowering Means

Any means can be used to raise or lower the sheets that are either taped or otherwise held together such that a “glue line” can be exposed and controlled. A mandrel (roll) is an example of a suitable means. The diameter of the mandrel can be selected to provide a specific opening dimension in the methods described herein. The mandrel can be of any suitable size that raises the sheets and exposes the area to be seamed. The shape of the mandrel may vary depending on the shape of the surface to be seamed.

Method of Seaming the Sheets

A. Preparing the Sheets

A set of two or more suitable sheets that are to be seamed together is selected. The sheets can have the same pattern, a different pattern, or can include no pattern (i.e., be a solid color). Each sheet can independently have a different color.

If the sheets have the same pattern, they are advantageously cut to have a seam that lines up with the pattern. The seam line can run parallel with the design, or can run at an angle from the design.

Although the sheets can be joined with a straight seam line, the line may alternatively be curved or otherwise shaped as long as the open seam area is capable of being controlled across the sheet. This embodiment may be particularly useful when generating a seamed covering out of differently colored materials, and where a welding rod would provide a seam that closely matches one of the two differently colored materials but would be noticeable at the interface between the differently colored sheets. Since the seam produced using the methods described herein is barely visible to invisible, the seaming method described herein can better hide the seam than when welding rods are used.

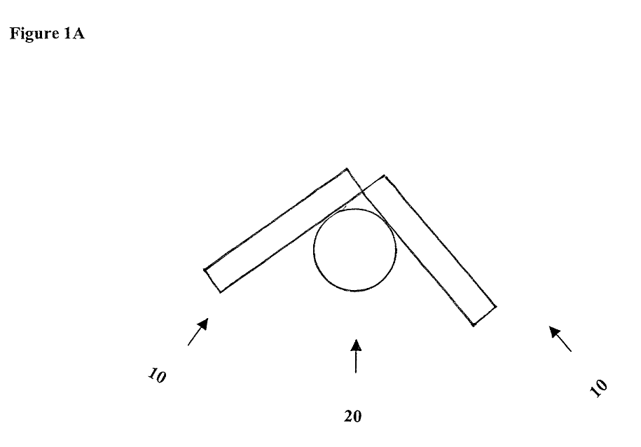

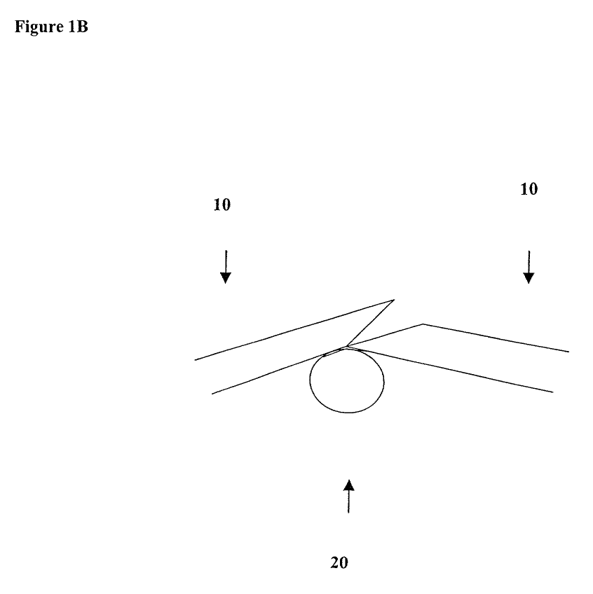

The methods described herein can also be used to prepare angled seams. This embodiment is particularly useful in developing high tensile (strong) seams. The coverings can be provided with a virtually undetectable seam. In this embodiment, the sheeting is cut so that the angles, when matched, provide a desired pattern. Accordingly, the surface to be glued may run at an angle other than perpendicular to the top and bottom surfaces of the sheet materials to be seamed. This embodiment is shown, for example, in FIGS. 1A and 1B.

In FIG. 1A, two pieces of sheet flooring (10) are cut at an approximate 90 degree angle such that, when adhered, the resulting sheet product is angled at the seam rather than flat. The two pieces are taped together at the seam and raised, for example, using a mandrel (20) to expose a gluing surface. Adhesive is then placed in the gluing surface and the mandrel is lowered.

In FIG. 1B, two pieces of flooring (10) are cut at an angle to form a “scarf joint” where the surfaces abut each other. After the pieces are taped together at the seam, they can be raised using a mandrel (20) or other raising/lowering means. The scarf joint provides a larger gluing surface relative to where the seams are parallel to the surface and accordingly can provide a stronger joint. This embodiment is described in additional detail in Example 4 below.

Seams can also be strengthened by shaping the edges of the sheets to be adhered together to define a predetermined void within the seam for retaining adhesive.

B. Lining Up the Sheets

Once a suitable pair of sheets is selected, and cut in a desired manner so that the seam is ready to be formed, the sheets are lined up and taped or otherwise held together on one surface at the seam. In one embodiment, the seam is prepared across machine dimension (AMD). The sheets can be aligned, for example, according to the methods described in U.S. Pat. No. 6,083,595, the contents of which are hereby incorporated by reference.

In one embodiment, the tape is applied to the surface(s) that will be exposed, i.e., the topmost surface of each of the sheets to be joined. The taping is preferably performed in a manner that preserves a desired pattern or design if one is present.

In one embodiment, the topmost surface is placed downward. This can be done before or after the sheets are taped together. For example, if the pattern is matched and the sheets are placed down, tape can be placed on one sheet in such a manner that there is additional tape surface with which to adhere the other sheet. The second sheet can then be placed on the additional tape surface such that it is in intimate contact with the first sheet. Alternatively, the sheets can lie face up with the pattern exposed, and tape or other suitable holding means placed along the seam in a manner that preserves the desired pattern, and then the taped sheets turned upside down so that the pattern is on the bottom side.

C. Raising/Lowering the Taped Sheets

The taped sheets are positioned in such a manner that there is little or no exposed “glue surface” between the sheets. A glue or gluing surface is defined as the surface on the two surface coverings to be joined that are in contact with each other along the length of the seam. After the sheets are taped together, a gluing surface is then exposed.

The taped sheets can be raised/lowered in any suitable manner that permits control of the exposed gluing surface. The geometry of the opening is provided in a controlled fashion.

In one embodiment where the taped surface is placed “down”, a mandrel (roll) or other sheet raising means can be placed under the taped seam and raised to expose a gluing surface. Alternatively, one or both sheets are lowered to expose a gluing surface. If the taped surface is “up”, it can be raised & bent around the mandrel, or one or both sheets can be raised to expose the gluing surface.

D. Adhering/Gluing the Seam

After the gluing surface is exposed, a suitable adhesive is applied to the gluing surface. The adhesive can be applied using any suitable application means, although in some embodiments, a needle or needle-like applicator may be useful to direct the flow of the adhesive to the gluing surface.

In some embodiments, an accelerator is added to speed the cure. The gluing surfaces may be pre-treated or post-treated with a curing catalyst or reactive material that either facilitates curing of the adhesive, or facilitates wet out and increases seam strength. Examples of such catalysts or reactive materials include accelerators for isocyanate/moisture reaction, epoxy curing catalysts or co-reactants, peroxide initiators, photoinitiators and the like. Such catalysts and reactive materials are well known to those of skill in the art of adhering surfaces together, and depend on the specific types of adhesives used.

In the case of cyanoacrylate or anaerobic adhesive materials, curing can begin rapidly when the seam is closed.

E. Raising/Lowering the Glued Seam

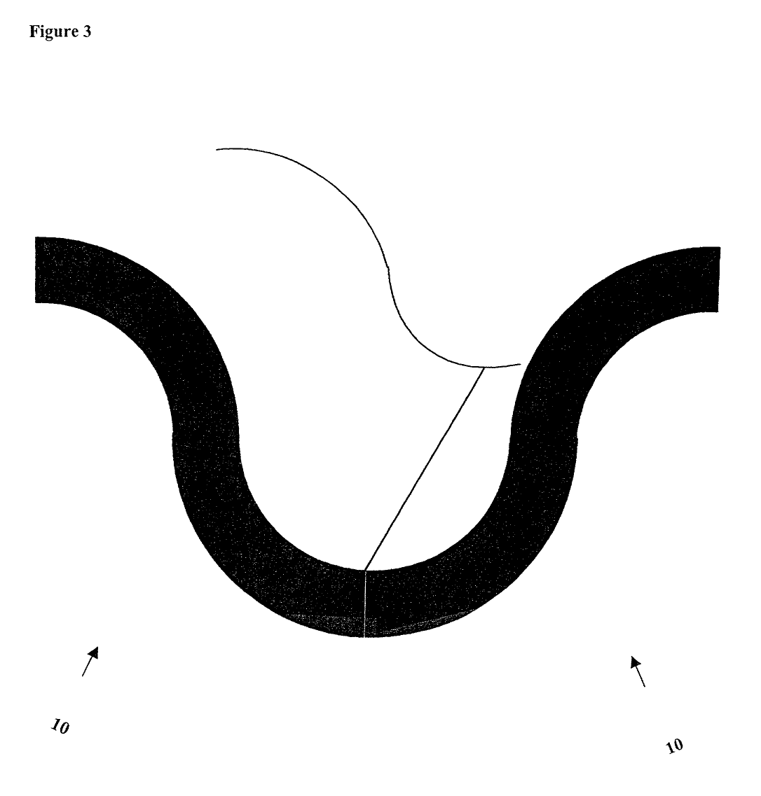

After the adhesive is applied, the raised region is lowered or the lowered sides are raised to the original height. In one embodiment, the seam area is formed as in FIG. 3 into a “U” shape to facilitate curing and removal of excess adhesive. Excess glue is optionally but advantageously removed, for example, by wiping or skiving the excess off of the non-taped surface.

After the raised region is lowered or lowered region raised, the adhesive is partially or totally set (i.e., cured or solidified). When hot melt adhesives are used, this typically involves cooling the sheets to solidify the hot melt adhesive. When UV curable adhesives are used, this typically involves exposing the adhesive to UV irradiation. When urethane adhesives are used, this typically involves allowing the curing reaction to take place. With cyanoacrylate type adhesives this generally involves allowing a suitable curing time.

After the adhesive has set, the tape or other sheet holding means can be removed and excess adhesive removed, for example, by skiving. Alternatively, while the top surface is being held in place by tape or other means, the fluid adhesive can be removed off the back surface by scraping, vacuuming, or wiping and then allowed to cure. The resulting surface covering or surface covering component can be rolled up and/or subjected to further process steps.

F. Optional Processing Steps

When the adhered sheets are surface covering components rather than finished surface coverings, additional processing steps can be performed to form finished surface coverings. In one embodiment, the additional processing involves adding a wear layer and/or a top coat layer. In this embodiment, equipment suitable for forming relatively narrow sheets can be used to prepare the surface covering component, and equipment suitable for applying one or more layers to relatively wider sheets can be used to form the finished surface covering. Additionally, it is also possible to apply the top coat layer onto the product after it has been installed in the customers location. In one embodiment, the topcoat is compatible with the seaming material in that it adheres and shows no difference in performance in the seam region verses other regions of the floor.

The present invention will be better understood with reference to the following non-limiting examples.

### EXAMPLE 1

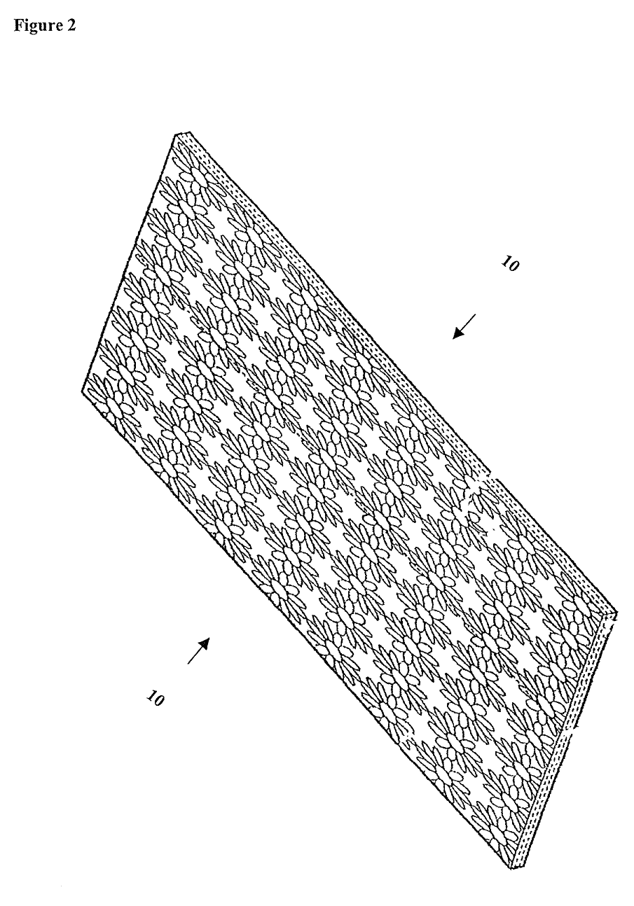

Two pieces of vinyl sheet flooring, specifically, Armstrong's Midstar product, were cut and the pattern matched (see FIG. 2, where the dashed line represents the seam between the two pieces (10)). A one inch piece of 3M 471 transparent plastic tape was positioned on the top of the seam throughout the entire length of the cut seam. The top of the tape was then rolled with a rubber roller to ensure adhesion in the chemically embossed areas of the sheet flooring. The sheet was then flipped over so that the printed side was down. A 5″ mandrel was then placed under the taped seam area. This provided for an opening in the seam that acted as a reservoir for the adhesive. A cyanoacrylate adhesive, specifically, Loctite 406, was applied to the seam using a 22 gauge needle, situated as the outlet for a plastic applicator bottle. The adhesive was applied at a rate of between 0.5 g to 1.0 g per foot throughout the length of the seam. The mandrel was then lowered and the floor was allowed to flatten. The excess adhesive was then wiped away with a cloth rag. The seam area was then allowed to rest and cure for about 3 minutes. The sheet floor was then flipped over, exposing the patterned floor and the taped seam. The tape was then removed, exposing the adhered seam in the vinyl sheet flooring. The seam area was then cleaned with isopropyl alcohol to remove residual tape adhesive. The sheet floor was then rolled up with the seams running the width of the roll.

### EXAMPLE 2

Two pieces of vinyl sheet flooring, specifically, Armstrong's Midstar product, were cut and the pattern matched as in Example 1. A one inch piece of 3M 471 transparent plastic tape was positioned under one cut edge, parallel with the cut edge throughout the entire length of the cut seam. A second edge was then positioned onto the tape so that no gap was visible. The top of the tape was then rolled with a rubber roller to ensure adhesion to the backside of the sheet floor. A 1″ mandrel was then placed under the taped seam area. This provided for an opening in the seam that acted as a reservoir for the adhesive. A cyanoacrylate adhesive, specifically, Loctite 406, was applied to the seam using a 22 gauge needle, situated as the outlet for a plastic applicator bottle. The adhesive was applied at a rate of between 0.5 g to 1.0 g per foot throughout the length of the seam. The mandrel was then removed. The flooring was then held in a “U” shape with the seam area positioned in the center of the down area of the “U” (FIG. 3, where parts 40 represent the sheets that were adhered together). The excess adhesive was then wiped away with a cloth rag. The seam area was then allowed to rest and cure for about 3 minutes. The sheet floor was then rolled up with the seams running the width of the roll. The tape was removed as in Example 1.

### EXAMPLE 3

Two pieces of vinyl sheet flooring, specifically, Armstrong's Midstar product, were cut and the pattern matched as in Example 1. A one inch piece of 3M 471 transparent plastic tape was positioned under one cut edge, parallel with the cut edge throughout the entire length of the cut seam. A second cut edge was then positioned onto the tape so that no gap was visible. The top side or non-adhesive side of the tape was then rolled with a rubber roller to ensure adhesion to the backside of the sheet floor. A 1″ mandrel was then placed under the taped seam area. When the mandrel was raised, this provided for an opening in the seam that acted as a reservoir for the adhesive. A cyanoacrylate adhesive, specifically, Loctite 406, was applied to the seam using a 22 gauge needle, situated as the outlet for a plastic applicator bottle. The adhesive was applied at a rate of between 0.5 g to 1.0 g per foot throughout the length of the seam. The mandrel was then removed. An adhesive accelerator, specifically Loctite 7452, was sprayed onto the residual adhesive that had seeped from the seam onto the non-taped side of the flooring. The flooring was then held in a “U” shape with the seam area positioned in the center of the down area of the “U” (FIG. 3). The excess adhesive was then wiped away with a cloth rag. An adhesive accelerator, specifically Loctite 7452, was sprayed onto the residual adhesive that had seeped from the seam onto the non-taped side of the flooring. The seam area was then allowed to rest and cure for about 3 minutes. The sheet floor was then rolled up with the seams running the width of the roll. The tape was removed as in Example 1.

### EXAMPLE 4

Two pieces of vinyl sheet flooring (10) are cut at an angle such that when glued, they form a scarf joint, and the pattern matched (FIG. 1B). A one inch piece of 3M 471 transparent plastic tape is positioned under one cut edge, parallel with the cut edge throughout the entire length of the cut seam. A second cut edge is then positioned onto the tape so that no gap was visible. The top of the tape is then rolled with a rubber roller to ensure adhesion to the backside of the sheet floor. A 1″ mandrel (20) (FIG. 1B) is then placed under the taped seam area. This provides for an opening in the seam that acts as a reservoir for the adhesive. A cyanoacrylate adhesive, specifically, Loctite 406, is applied to the seam using a 22 gauge needle, situated as the outlet for a plastic applicator bottle. The adhesive is typically applied at a rate of between 0.5 g to 1.0 g per foot throughout the length of the seam. The mandrel is then removed. An adhesive accelerator, specifically Loctite 7452, can be sprayed onto any residual adhesive that seeps from the seam onto the non-taped side of the flooring. The flooring can then be then held in a “U” shape with the seam area positioned in the center of the down area of the “U”. The excess adhesive can then be wiped away with a cloth rag. The seam area can then be allowed to rest and cure for a suitable amount of time, which is typically about 3 minutes. The sheet floor can then be rolled up with the seams running the width of the roll. The tape can be removed as in Example 1.

It is to be understood that various changes may be made in the function and arrangement of parts; equivalent means may be substituted for those illustrated and described; and certain features may be used independently from others without departing from the spirit and scope of the invention as defined in the following claims.

We claim:

1. A method for seaming a surface covering or surface covering component comprising:
a) placing two sheets, each having a first major surface and a second major surface and a gluing surface interposed between the first surface and the second surface, together with the intersection of the gluing surface and the first surface on each sheet directly adjacent one another and the two sheets in a desired orientation,
b) taping or otherwise holding the first surface of the sheets so that the sheets are held together with the intersection of the gluing surface and the first surface on each sheet directly adjacent one another,
c) exposing the gluing surfaces,
d) applying a suitable amount of an adhesive to at least one of the gluing surfaces while the gluing surface is exposed, and
e) positioning the sheets so that the gluing surfaces are directly adjacent.

2. The method of claim 1, further comprising winding the glued sheets into a roll.

3. The method of claim 2, wherein the gluing surfaces are substantially in a plane perpendicular to the axis of the roll.

4. The method of claim 1, wherein the gluing surfaces are directly adjacent to one another when the first surfaces are taped or otherwise held together before exposing the gluing surfaces.

5. The method of claim 1, wherein when the sheets are placed adjacent to one another in the desired orientation, a desired pattern is obtained.

6. The method of claim 1, further comprising removing excess adhesive.

7. The method of claim 1, further comprising allowing the adhesive to set or cure.

8. The method of claim 7, further comprising removing the tape after the adhesive is cured.

9. The method of claim 1, wherein the two sheets are floor covering components.

10. The method of claim 1, wherein the two sheets are each of a different color.

11. The method of claim 1, wherein the gluing surface of the sheets is perpendicular to the first surface.

12. The method of claim 1, wherein the seam is a substantially straight line.

13. The method of claim 12, wherein the seam runs parallel to a printed pattern.

14. The method of claim 1, wherein the adhesive is selected from the group consisting of hot melt glues, radiation-curable adhesives, moisture-curable adhesives and anaerobic-curable adhesives.

15. The method of claim 14, wherein the radiation-curable adhesive is a UV curable adhesive.

16. The method of claim 14, wherein the adhesive is a cyanoacrylate.

17. The method of claim 1, wherein the adhesive is fluid when applied.

18. The method of claim 1, wherein the seam area does not scratch, stain, or discolor in use at a rate substantially different than the remainder of the surface covering.

19. The method of claim 1, wherein the strength of the seamed area exceeds that of the remainder of the surface covering or surface covering component.

20. The method of claim 1, wherein the sheets are in the form of a surface covering component, and the method further comprises applying one or more additional layers to the seamed surface covering components to form a finished surface covering.

21. A surface covering component comprising two elements, each element comprising a first major surface and a second major surface and a gluing surface interposed between the first surface and the second surface, the gluing surfaces of the two elements being adjacent, and an adhesive interposed between the gluing surfaces.

22. The surface covering component of claim 21, wherein the adhesive is selected from one or more of a hot melt glue, a radiation-curable adhesive, a moisture-curable adhesive and an anaerobic-curable adhesive.

23. The surface covering component of claim 22, wherein the radiation-curable adhesive is a UV curable adhesive.

24. The surface covering component of claim 22, wherein the adhesive is a cyanoacrylate.

25. The surface covering component of claim 21, wherein the surface covering component is a resilient floor covering component.

26. The surface covering component of claim 25, wherein the resilient floor covering component comprises a substrate, a foam layer and a design layer.

27. The surface covering component of claim 22, further comprising a seamless wear layer and/or a top coat layer that covers substantially the entire surface covering component.

28. A resilient floor covering comprising two elements, each element comprising a first major surface and a second major surface and a gluing surface interposed between the first surface and the second surface, the gluing surfaces of the two elements being adjacent, and an adhesive interposed between the gluing surfaces, wherein the gluing surfaces are not perpendicular to the first major surface.

29. A floor covering prepared according to the method of claim 1.

30. The floor covering of claim 29 in the form of a roll.

31. The floor covering of claim 29, wherein the adhesive is a radiation-curable adhesive.

32. The floor covering of claim 29, wherein the adhesive is UV-curable.

33. The floor covering of claim 29, wherein the adhesive is a cyanoacrylate.

34. A surface covering comprising two elements, each element comprising a first major surface and a second major surface and a gluing surface interposed between the first surface and the second surface, the gluing surfaces of the two elements being adjacent, and an adhesive interposed between the gluing surfaces,
wherein the surface covering is in the form of a roll, with the gluing surfaces being in a plane perpendicular to the axis of the roll, the gluing surfaces and adhesive forming a seam, and the thickness of the seam being substantially no greater than the thickness of the elements.
